(19) United States
(12) Patent Application Publication
(10) Pub. No.: US 2005/0187772 A1
(43) Pub. Date: Aug. 25, 2005

(54) Systems and methods for synthesizing speech using discourse function level prosodic features

(75) Inventors: Misty Azara, Seattle, WA (US); Livia Polanyi, Palo Alto, CA (US); Giovanni L. Thione, San Francisco, CA (US); Martin H. Van Den Berg, Palo Alto, CA (US)

Correspondence Address: Christian Austin - Hollands Esq., PO Box 170325, San Francisco, CA, 94117, US

(73) Assignee: FUJI XEROX CO., LTD.

(21) Appl. No.: 10/785,199

(22) Filed: Feb. 25, 2004

(51) Int. Cl. G10L 13/00

(52) U.S. Cl. 704/260

(57) ABSTRACT

Techniques are provided for synthesizing speech using discourse function level prosodic features. An output text is determined. The discourse functions within the text are determined based on a theory of discourse analysis such as the Unified Linguistic Discourse Model. The salient prosodic features associated with the discourse functions are identified using a predictive model of discourse functions or some other model of salient prosodic features. The discourse functions are transformed into synthesized speech. Discourse function level prosodic feature adjustments are determined and applied to the synthesized speech is output.

### BACKGROUND OF THE INVENTION

1. Field of Invention

This invention relates to speech synthesis.

2. Description of Related Art

Speech can be used to communicate information using different aspects or channels. The salient communicative aspects of speech is typically communicated through the explicit information of the speech. However, intonation, word stress and various other prosodic features can also be used to provide a parallel channel of information. Thus, prosodic features can be used to mark important portions of the speech, support and/or contradict the explicit information and/or provide any other information context for the speech recipient. Erroneously placed and/or missing prosodic features can re-direct the speech recipient's attention from the speech to the context of the speech. In some situations such as plays, speeches and the like, these re-directions are used to amuse and/or educate the speech recipient. However, in situations involving command and control and/or other human computer interface environments, the explicit communicative content of the speech is critical. Increased cognitive load in a command and/or control situation can critically delay and/or prevent the proper understanding of the speech. Therefore, in these situations, the prosodic features of the speech should reduce and/or eliminate re-directions in order to reduce cognitive load. For example, computer synthesized English language speech is difficult to understand since it lacks the intonation, pauses and other prosodic features expected in human speech. The lack of prosodic features reduces the effectiveness of computer synthesized speech interfaces.

Some conventional speech synthesis systems have attempted to address these problems by adding prosodic features to computer synthesized speech. U.S. Pat. No. 5,790,978 describes adding prosodic contours to synthesized speech while U.S. Pat. No. 5,790,978 describes selecting formant trajectories based on timing.

### SUMMARY OF THE INVENTION

The systems and methods according to this invention determine discourse functions for output information based on a theory of discourse analysis. In one of the exemplary embodiments according to this invention, the discourse functions are determined using the Unified Linguistic Discourse Model of Polanyi et al., as further described in co-pending co-assigned U.S. patent application Ser. No. 10/684,508, entitled “Systems and Methods for Hybrid Text Summarization”, attorney docket # FX/A3010-317006, filed Oct. 15, 2003, and incorporated herein by reference in its entirety.

A model of salient prosodic features such as a predictive model of discourse functions is used to identify discourse level prosodic features. The discourse function level prosodic features are used to adjust the synthesized speech output. In one of the various exemplary embodiments according to this invention, the discourse function level prosodic features are represented as waveforms reflecting the discourse function level prosodic features to be added to the synthesized speech output. In various other exemplary embodiments according to this invention, the model of salient discourse function level prosodic features is based on a predictive model of discourse functions as further described in co-assigned, co-pending U.S. patent application Ser. No. XX/XXX,XXXX, by Azara et al., entitled “Systems and Methods for Determining Predictive Models of Discourse Functions”, attorney docket # FX/A3007-317003, filed on Feb. 18, 2004 and incorporated herein by reference in its entirety. An adjusted synthesized speech output is determined based on discourse functions within the synthesized speech output and the discourse function level prosodic features.

### BRIEF DESCRIPTION OF THE DRAWINGS

FIG. 1 is an overview of an exemplary system for synthesizing speech using discourse function level prosodic features according to this invention;

FIG. 2 is a first exemplary method of synthesizing speech using discourse function level prosodic features according to this invention;

FIG. 3 is an overview of an exemplary system for synthesizing speech using discourse level prosodic features according to this invention;

FIG. 4 is an expanded view of an exemplary method of determining prosodic features according to this invention;

FIG. 5 shows an exemplary discourse structure pitch frequency graph;

FIG. 6 is an exemplary data structure for storing exemplary prosodic feature vectors according to this invention;

FIG. 7 is an exemplary data structure for storing augmented prosodic feature vectors according to this invention;

FIG. 8 is an exemplary data structure for storing models of salient discourse function level prosodic features according to this invention;

FIG. 9 is an exemplary discourse function level prosodic feature waveform associated with “COMMAND” and “DATA” discourse functions;

FIG. 10 is a first exemplary adjusted synthesized speech waveform according to one aspect of this invention;

FIG. 11 is a second exemplary method of synthesizing speech using discourse function level prosodic features according to this invention; and

FIG. 12 is an exemplary data structure for storing combined prosodic features according to one aspect of this invention;

### DETAILED DESCRIPTION OF EXEMPLARY EMBODIMENTS

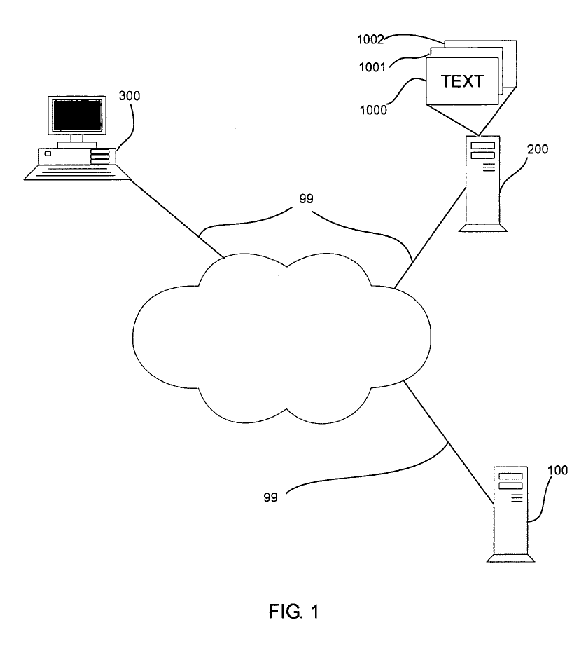

FIG. 1 is an overview of an exemplary system for synthesizing speech using discourse function level prosodic features according to this invention. The system for synthesizing speech using discourse function level prosodic features 100 is connected via communications link 99 to an internet-enabled personal computer 300 and an information repository 200 containing information and/or texts 1000-1002.

In one of the various exemplary embodiments according to this invention, a user of the internet-enabled personal computer 300 initiates a request to synthesize speech based on the text 1000. The text 1000 may be associated with any type of information to be output to the user via speech. For example, the text may include but is not limited to directions to locations of interest, details of bank and/or credit card transactions or any other known or later developed type of information. The speech synthesis request is forwarded over communications link 99 to the system for synthesizing speech using discourse function level prosodic features 100. The system for synthesizing speech using discourse function level prosodic features 100 retrieves the text 1000 from the information repository 200. The discourse functions in the text 1000 are then determined using a theory of discourse analysis. The salient prosodic features associated with each discourse function are determined. In one of the exemplary embodiments according to this invention, a previously determined predictive model of discourse functions is used to determine the prosodic features for the discourse function. In still other exemplary embodiments according to this invention, the predictive model of discourse functions may include augmented prosodic features helpful in producing more natural sounding speech.

The prosodic features associated with a discourse function may include but are not limited to fundamental frequency information, intonational phrase tones, boundary tones, inter-utterance silence duration, rate of speech and the like. However, it will be apparent that any known or later determined prosodic feature useful in synthesizing discourse level natural language speech may also be used in the practice of this invention.

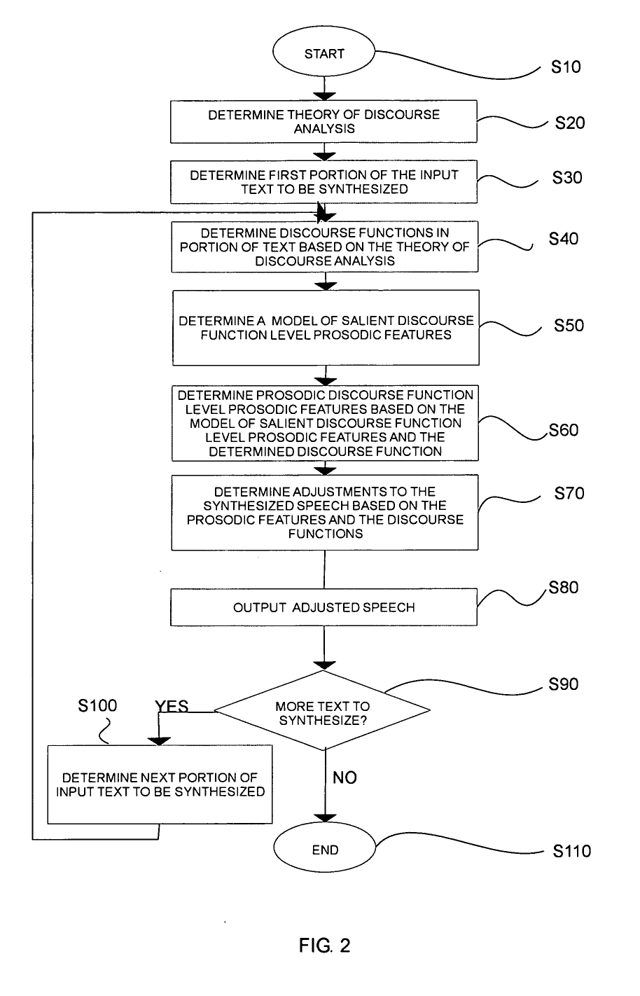

FIG. 2 is a first exemplary method of synthesizing speech using discourse function level prosodic features according to this invention. The process begins at step S10 and immediately continues to step S20. In step S20, a theory of discourse analysis is determined. For example, the theory of discourse analysis may be determined based on the type of speech to be synthesized, selected based on the user, the task to be performed or any other method. The theory of discourse analysis may include any theory of discourse analysis capable of identifying discourse functions in a text. Thus, in one of the various exemplary embodiments according to this invention, the Unified Linguistic Discourse Model (ULDM) is used to determine discourse functions based on a mapping of basic discourse constituents to discourse functions. Discourse functions are intra-sentential and/or inter-sentential phenomena that are used to accomplish task, text and interaction level discourse activities such as giving commands to systems, initializing tasks identifying speech recipients and marking discourse level structures such as the nucleus and satellite distinction described in Rhetorical Structures Theory, the coordination, subordination and N-aries, as described in the ULDM and the like. That is, in some cases, the discourse constituent of the selected theory of discourse analysis may correlate with a type of discourse function. After the theory of discourse analysis has been determined, control continues to step S30.

In step S30, the first portion of the input text to be synthesized is determined. In various exemplary embodiments according to this invention, the input text is selected from a group of files using a mouse, voice selection or any other method of selecting text. In still other embodiments according to this invention, the input text is generated dynamically by another application, a process, a system and the like. After the input text has been determined, control continues to step S40.

The discourse functions in the selected portion of the selected text are then determined based on a theory of discourse analysis in step S40. In one of the various embodiments, the discourse functions are identified based on a mapping between the basic discourse constituents of the theory of discourse analysis and a set of discourse functions. After the discourse functions in the text have been determined, control continues to step S50.

In step S50, a model of salient discourse function level prosodic features is determined. In one of the exemplary embodiments, a predictive model of discourse functions serves as the model of salient prosodic features. In still other embodiments, predictive models of discourse functions are determined based on the systems and methods described in “Systems and Methods for Determining Predictive Models of Discourse Functions” as discussed above. However, it will be apparent that any known or later developed method of determining a model of salient discourse functions level prosodic features may also be used in the practice of this invention.

The prosodic features associated with each discourse function are determined in step S60. That is, the model of salient discourse function level prosodic features is used to determine the prosodic features for a given discourse function. However, in various other exemplary embodiments, a predictive model for discourse functions is used as the model of salient discourse function level prosodic features. The predictive model of discourse functions encodes prosodic features that differentiate between the discourse functions recognized by a theory of discourse analysis.

The salient discourse function level prosodic features are encoded into one or more discourse function level prosodic feature waveforms. The salient discourse function level prosodic features may include but are not limited to specific pitch frequency values, speed, intonation, and the like. The salient discourse functions level prosodic feature waveform forms a template of discourse function level prosodic features typically associated with the specified discourse function in human speech. The salient prosodic features may also be encoded into vectors, equations and or any other data structure and/or representation without departing from the scope of this invention. After the model of salient discourse function level prosodic features has been determined, control continues to step S70.

In step S70, adjustments to the discourse functions in the speech output are determined based on the discourse function level prosodic features. In one of the exemplary embodiments according to this invention, discourse function level prosodic waveforms are combined with the waveforms from a conventional text-to-speech conversion system. Smoothing functions are then optionally applied. Since the prosodic features are mapped to discourse functions that in-turn reflect dialog acts, the reproduction of the prosodic features reduces the potential cognitive load on the speech recipient. In other exemplary embodiments according to this invention, discourse function level prosodic feature adjustments may also be performed on parameterized speech output. Moreover, it will be apparent that the speech may be adjusted before, during or after speech output generation without departing from the scope of this invention. After the adjusted synthesized speech has been determined, control continues to step S80.

In step S80, the adjusted synthesized speech is output. The adjusted synthesized speech may be output over a telephone system, an audio device or via any known or later developed communication medium. In various other exemplary embodiments according to this invention, the adjusted speech output may be prosodically annotated text, input to another program or any other type of adjusted synthesized speech information. After the adjusted synthesized speech has been output, control continues to step S90.

In step S90, a determination is made whether there are additional text portions to be synthesized. If it is determined that there are additional text portions to be synthesized, control continues to step S100 where the next portion of the input text is determined. After the next portion of the input text has been determined, control jumps immediately to step S40. Steps S40-S100 are repeated until it is determined in step S90 that no additional text portions remain to be synthesized. Control then continues to step S110 and the process ends.

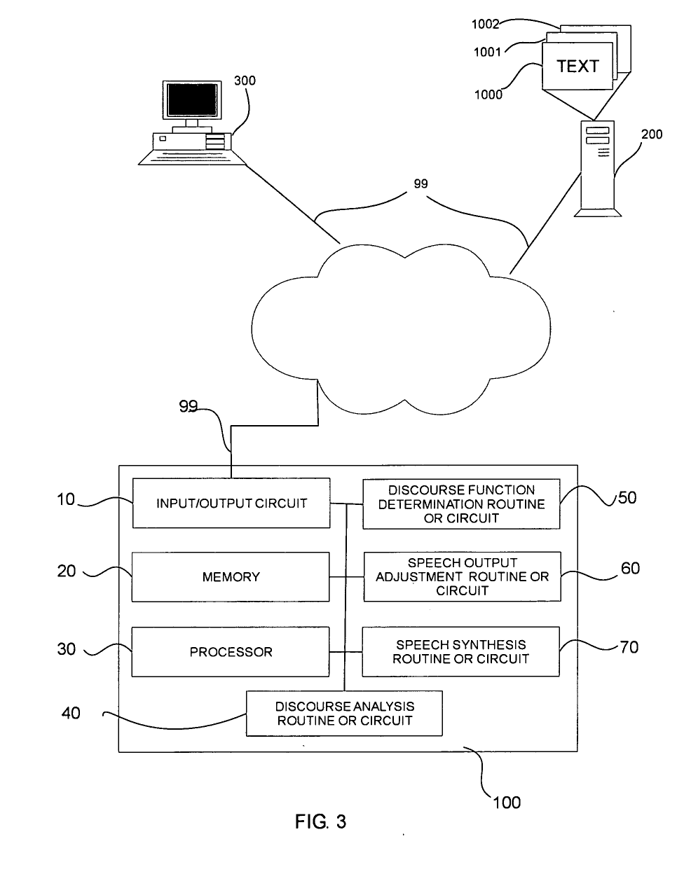

FIG. 3 is an overview of an exemplary system for synthesizing speech using discourse level prosodic features according to this invention. The system for synthesizing speech using discourse level prosodic features 100 is comprised of a memory 20; a processor 30; a discourse analysis routine or circuit 40; a discourse function determination routine or circuit 50; a speech output adjustment routine or circuit 60; and a speech synthesis routine or circuit 70, each connected via input/output circuit 10 and communications link 99 to an information repository 200 and an internet-enabled personal computer 300.

A user of the internet-enabled personal computer 300 initiates a request to convert the text 1000 contained in the information repository 200 into speech information. The request is mediated by the system for synthesizing speech using discourse level prosodic features 100. The processor 30 activates the input/output circuit 10 to retrieve the text 1000 from the information repository 200. The text 1000 is then stored in memory 20. The processor 30 activates the discourse analysis routine or circuit 40 to analyze the text. In one of the various exemplary embodiments according to this invention, the text is analyzed using a theory of discourse analysis such the ULDM. The ULDM segments the text into basic discourse constituents. In the ULDM, discourse constituents encode the smallest unit of meaning in the text. A mapping may then be used to combine one or more basic discourse constituents to form a discourse function. However, it will be apparent that the discourse analysis circuit or routine may be designed to use any known or later developed theory of discourse analysis capable of segmenting a text.

The processor 30 then activates the discourse function determination routine or circuit 50 to determine the discourse functions in the text. As discussed above, discourse functions are inter and/or intra-sentential phenomena used to accomplish task, text and/or interactive level discourse activities such as giving commands to systems, initializing tasks, identifying speech recipients, and marking discourse level structures. After the discourse functions have been determined, the processor 30 activates the speech output adjustment routine or circuit 60.

The speech output adjustment routine or circuit 60 determines discourse function level prosodic feature adjustments to the synthesized speech output information. The adjustments may be retrieved from a predictive model of discourse functions. The predictive model of discourse functions associates exemplary prosodic features with each type of discourse function. Thus, given a determined discourse function, the predictive model of discourse functions returns the exemplary prosodic features associated with the discourse function. However, it will be apparent that any known or later developed model of salient discourse function level prosodic features may be used in the practice of this invention.

The exemplary discourse function level prosodic features associated with the determined discourse functions are then applied by processor 30 to transform the synthesized speech output information into adjusted speech output information. For example, exemplary discourse function level prosodic features associated with a discourse function indicate specific amplitudes, frequencies, silence durations, stresses and other prosodic features. After the processor 30 has determined the adjusted synthesized speech output information, the speech synthesis routine or circuit 70 is activated.

The speech synthesis routine or circuit 70 is activated to determine the audio signals and/or signal waveforms necessary to generate the sounds of the adjusted synthesized speech output information. In still other exemplary embodiments, the speech adjustment circuit or routine 60 and the speech synthesis circuit or routine 70 are integrated into a single circuit or routine. The adjusted synthesized speech is then output over the communications link 99 to the user of internet enabled personal computer 300 as speech information. It will be apparent that in various other exemplary embodiments according to this invention, the adjusted speech information may be output to a telephone (not shown) or any other communications device.

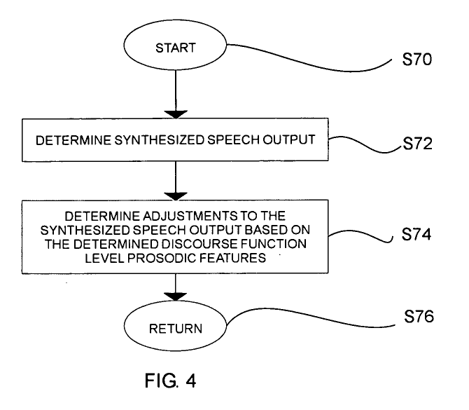

FIG. 4 is an expanded view of an exemplary method of determining adjustments to the synthesized speech based on the prosodic features and the discourse functions according to this invention. The process begins at step S70 and immediately continues to step S72.

In step S72, the synthesized speech output is determined. In various exemplary embodiments according to this invention, the synthesized speech output is derived from a conventional speech synthesizer. However, it should be apparent that parameterized speech, text marked up for a speech synthesizer or any known or later developed synthesized speech output may also be used in the practice of this invention. After the synthesized speech output has been determined, control continues to step S74.

In step S74, adjustments to the synthesized speech output are determined based on the discourse function level prosodic features. Thus, in one of the exemplary embodiments according to this invention, the discourse function level prosodic features are combined with the synthesized speech output to determine an adjusted synthesized speech output. After the adjusted synthesized speech output has been determined, control continues to step S76. Control then immediately returns to step S80 of FIG. 2.

FIG. 5 shows an exemplary discourse function pitch frequency graph 800. The exemplary discourse structure 800 is comprised of the two phrases “And the body is”, and “Hi Brian”. The exemplary discourse function pitch frequency graph 800 reflects an interaction between a user and the natural language speech interface of an email system. The command portion 810 of the exemplary data structure 800 contains the value “And the body is”. This value reflects a command to the email system. That is, the command indicates that the user has decided to enter the body of an email message. The second or data portion 820 of the exemplary discourse structure contains the value “Hi Brian” indicating the data to be included in the message. The prosodic features J₁-J₃ 831-833 segment the discourse structure into the respective command portions 810 and data portions 820.

The prosodic features 831-833 are also used to classify the segments portions into types of discourse functions. The types of discourse functions may include but are not limited to “COMMAND”, “DATA”, “SURBORDINATION”, “COORDINATION” and the like. The prosodic features may include initial frequency, pitch variation, speed, stress or any other known or later developed prosodic feature useful in determining discourse functions. It will be apparent that in various other exemplary embodiments according to this invention, one or more prosodic features may be combined to form a combined prosodic feature without departing form the scope of this invention.

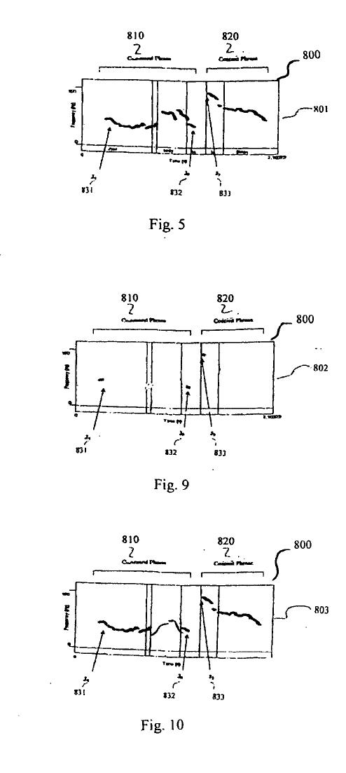

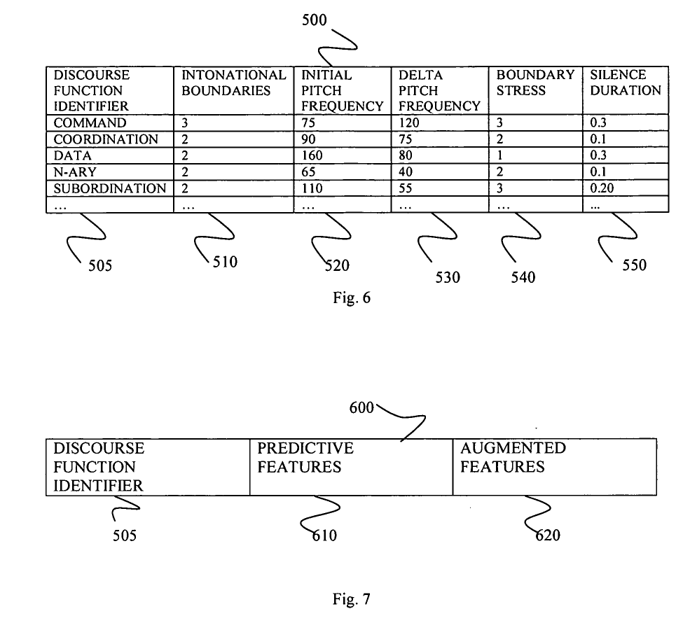

FIG. 6 is an exemplary data structure for storing exemplary prosodic feature vectors 500 according to this invention. The exemplary data structure for storing prosodic feature vectors 500 is comprised of a discourse function identifier portion 505; an intonational boundaries portion 510; an initial pitch frequency portion 520; a delta pitch frequency portion 530; a boundary stress portion 540; and a silence duration portion 550. It will be apparent that the prosodic features described above are merely exemplary and that any known or later developed discourse function level prosodic feature may be used in the practice of this invention.

The first row of the exemplary data structure for storing prosodic feature vectors contains “COMMAND” in the discourse function identifier portion 505 indicating that the associated prosodic features are associated with a discourse function of type “COMMAND”. The intonation boundaries portion 510 contains the value “3”. This indicates the number of intonational boundaries typically associated with a discourse function of type “COMMAND”. The initial pitch frequency portion 520 contains the value “75” indicating the initial pitch frequency typically associated with discourse functions of type “COMMAND”.

The delta pitch frequency portion 530 contains the value “120”. This reflects the range of pitch frequencies typically associated with discourse functions of type “COMMAND”. The boundary stress portion 540 contains the value “3” this indicates that discourse functions of type “COMMAND” are associated with a stress on the third boundary. The silence duration portion 550 contains the value “0.30” indicating that a silence of 0.3 seconds is typically associated with discourse functions of type “COMMAND”.

The second row of the exemplary data structure for storing prosodic feature vectors 500 contains the values “COORDINATION, 2, 90, 75, 2, 0.1” respectively. These values indicate that “COORDINATION” discourse functions are typically associated with 2 intonational boundaries, an initial pitch frequency of 90, a delta pitch frequency of 75, a boundary stress on the second boundary and a silence duration of 0.1 seconds.

The third row of the exemplary data structure for storing prosodic feature vectors 500 contains the value “DATA” in the discourse function portion 505. This indicates that the prosodic features relate to a “DATA” discourse function. The intonational boundaries portion 510, the initial pitch frequency portion 520, the delta pitch frequency portion 530, the boundary stress portion 540 and the silence duration portion 550 contain the values “2, 160, 80, 1 and 0.3” respectively. These values indicate the exemplary prosodic features associated with discourse functions of type “DATA”.

The fourth row of the exemplary data structure for storing prosodic feature vectors 500 contains the values “N-ARY, 2, 65, 40, 2, 0.1” respectively. These values indicate that “N-ARY” discourse functions are typically associated with 2 intonational boundaries, an initial pitch frequency of 65, a delta pitch frequency of 40, a boundary stress on the second boundary and a silence of 0.1 seconds in duration.

The fifth row of the exemplary data structure for storing prosodic feature vectors 500 contains the value “SUBORDINATION” in the discourse function portion 505. This indicates that the prosodic feature vector is associated with a “SUBORDINATION” discourse function. The intonational boundary portion 510 contains the value “2”. This indicates that discourse functions of type “SUBORDINATION” are typically associated with speech utterances having 2 intonation boundaries.

The initial fundamental frequency portion 520 contains the value “110”. This indicates the initial fundamental frequency typically associated with discourse functions of type “SUBORDINATION”. The frequency ranges may be specified in Hertz or any other unit of frequency measurement.

The delta pitch frequency portion 530 contains the value “55” indicating the change or variance in pitch frequency typically associated with “SUBORDINATION” discourse functions. For example, “SUBORDINATION” type discourse functions are typically associated with a pitch frequency range of 55 Hz. The discourse functions having a range of pitch frequencies outside this range are less likely to be “SUBORDINATION” type discourse functions depending on any weighting associated with the delta pitch frequency prosodic feature.

The boundary stress portion 540 contains the value “3”. This indicates that stress is placed on the third intonational segment of the speech utterance. The silence portion 550 contains the value “0.20” indicating the silence associated with discourse functions of type “SUBORDINATION”. In various other exemplary embodiments according to this invention, the various prosodic features are also associated with a location or relative time within the speech utterance. The specific values discussed above are idiosyncratic. Thus, in various other exemplary embodiments according to this invention, user training and/or other methods of normalizing the discourse function level prosodic features are used in this invention.

FIG. 7 is an exemplary data structure for storing augmented prosodic feature vectors 600 according to this invention. The exemplary data structure for storing augmented prosodic feature vectors 600 is comprised of a discourse function identifier portion 505; a predictive feature portion 610; and an augmented feature portion 620. The prosodic features in the predictive features portion differentiate between discourse functions. However, additional or augmented prosodic features that do not necessarily differentiate between discourse functions can also be used in the practice of this invention. These augmented prosodic features are contained in the augmented feature portion 620 of the exemplary data structure for storing augmented prosodic feature vectors 600.

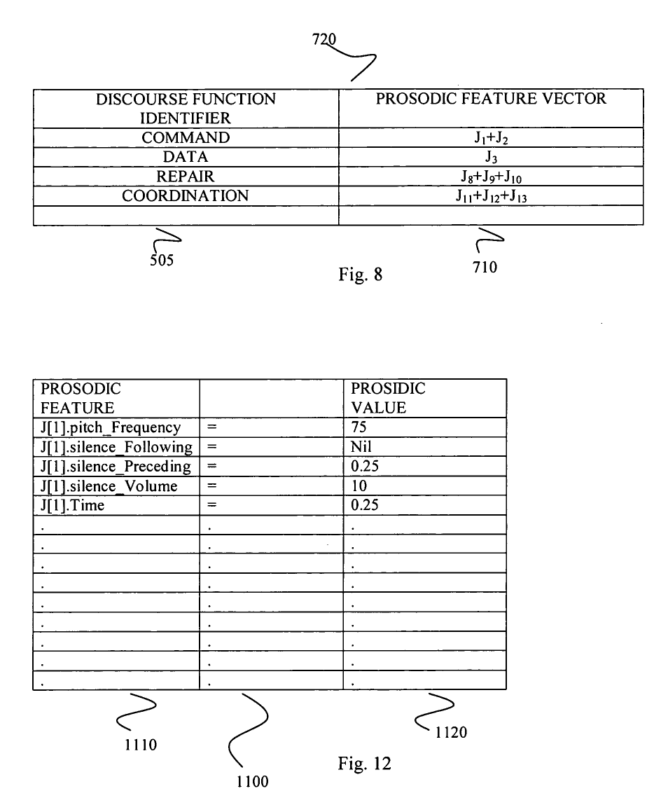

FIG. 8 is an exemplary data structure for storing models of salient discourse function level prosodic features 700 according to one aspect of this invention. The exemplary data structure for storing models of salient discourse function level prosodic features is comprised of a discourse function identifier portion 505 and a prosodic feature vector portion 710.

The first row of the exemplary data structure for storing models of salient discourse function level prosodic features 700 contains the value “COMMAND” in the discourse identifier portion 505. This indicates that the prosodic features specified in the prosodic feature vector portion 710 are associated with a discourse function of type “COMMAND”. The prosodic feature vector portion 710 contains the value “J₁+J₂” indicating that prosodic features J₁ and J₂ are added to “COMMAND” type discourse functions.

The second row of the data structure for storing predictive models of discourse functions 700 contains the value “DATA” in the discourse function identifier 505 and the value “J₃” in the prosodic feature vector portion 710. This indicates that the prosodic features are associated with a “DATA” type of discourse function. It will be apparent that the use of prosodic feature vectors is merely exemplary and that any method of encoding salient information may be used in the practice of this invention.

The third row of the data structure for storing predictive models of discourse function level prosodic features contains a prosodic feature vector associated with speech repair discourse functions. Thus, the discourse functions identifier 505 contains the value “REPAIR” as the identifier for the prosodic feature vector. The prosodic feature vector portion 710 contains the prosodic feature value “J₈+J₉+J₁₀”. This indicates that prosodic features “J₈+J₉+J₁₀” have been combined into a prosodic feature vector. The prosodic features associated with the prosodic feature vector are added to identified speech repair discourse functions.

The fourth row of the data structure for storing models of salient discourse function level prosodic features contains prosodic features associated with coordinations. Thus, the discourse function identifier 505 contains the value “COORDINATION”. This value identifies the prosodic feature vector. The prosodic feature vector portion 710 contains the value “J₁₁+J₁₂+J₁₃”. This value reflects the prosodic features that have been combined into the “COORDINATION” prosodic feature vector. These prosodic features are added to each “COORDINATION” type discourse function.

FIG. 9 is an exemplary discourse function level prosodic feature waveform associated with “COMMAND” and “DATA” discourse functions. The discourse function level prosodic feature waveform encodes prosodic features associated with the determined discourse functions. In a first exemplary embodiment according to this invention, the prosodic features are the prosodic features associated with a predictive model of discourse functions. However, in various other embodiments according to this invention, additional or augmented prosodic features may be added.

The predictive prosodic features associate salient discourse functions level prosodic features with discourse functions. Additional or augmented prosodic features helpful in synthesizing speech may also be associated with discourse functions within the predictive model. For example, augmented prosodic features that help improve the prosody of the synthesized speech but which do not necessarily assist in predicting the likely discourse function classification of a speech utterance may be included in an augmented portion of the predictive model. The exemplary discourse function level prosodic feature waveform of the “COMMAND” discourse function is combined with the speech output to generate transformed speech information containing discourse function level prosodic features.

FIG. 10 is an exemplary adjusted synthesized speech waveform according to one aspect of this invention. The prosodic features J₁-J₃ 831-833 associated with discourse functions of type “COMMAND” and “DATA” are identified. The discourse function level prosodic features J₁-J₃ 831-833 are then used to transform the speech output associated with the phrase “And the message is, Hi Brian”. For example, in one of the various exemplary embodiments according to this invention, speech output is derived from a conventional speech synthesis system. Thus, the discourse function level prosodic features are used to transform the speech output of the conventional speech synthesis system. It will be apparent that in still other exemplary embodiments according to this invention, adjustments may occur before, during or after the speech synthesis step without departing form the scope of this invention. Thus, if a parameterized speech synthesizer is used in the practice of this invention, adjustments are made to the speech synthesis parameters without the need to generate and transform a conventional synthesized speech output waveform.

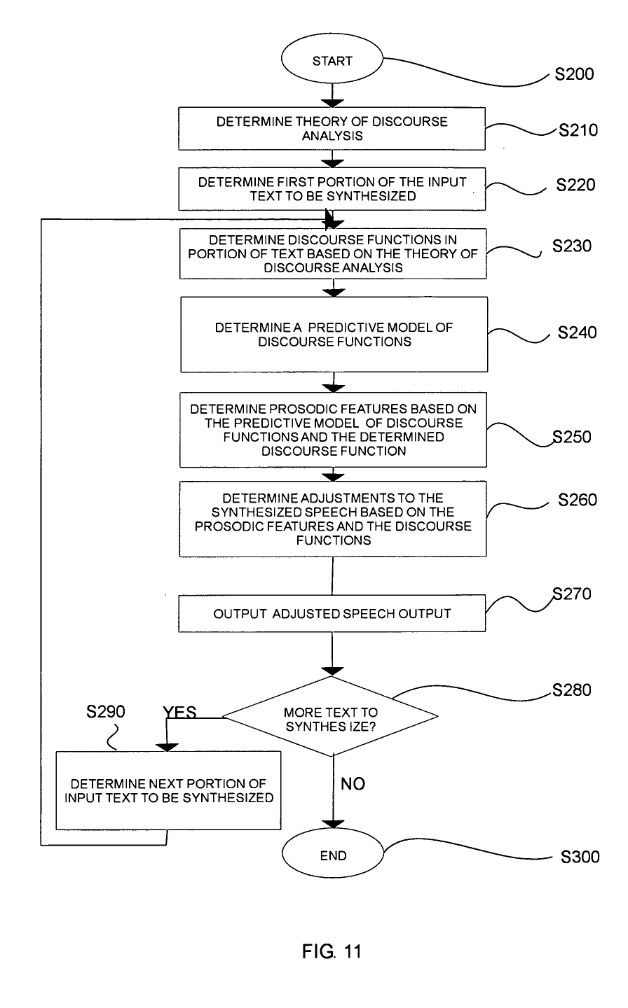

FIG. 11 is a second exemplary method of synthesizing speech using discourse function level prosodic features according to this invention. The process begins at step S200 and immediately continues to step S210 where a theory of discourse analysis is determined. After the theory of discourse analysis has been determined, control continues to step S220.

In step S220, a first portion of the input text to be synthesized is determined. The input text to be synthesized is selected from a group of files using a mouse, voice selection or any other method of selecting text. In still other embodiments according to this invention, the input text to be synthesized may be generated dynamically by another application, a process, a system and the like. After the input text has been determined, control continues to step S230 where the discourse functions in the selected portion of the input text are determined based on a theory of discourse analysis.

The discourse functions may include but are not limited to coordination, subordination, n-aries, command, data nucleus, satellite or any other known or later developed discourse functions. In one of the various embodiments, the discourse functions are identified based on a mapping between the basic discourse constituents of the theory of discourse analysis and a set of discourse functions. After the discourse functions in the input text have been determined, control continues to step S240.

In step S240, a predictive model of discourse functions is determined. The predictive model of discourse functions may be determined based on the user preferences, specific applications or based on various other selection criteria. Thus, different predictive models of discourse functions are used to change the prosodic style of the synthesized speech output.

The prosodic features that are associated with the discourse function are determined in step S250. For a given discourse function, the predictive discourse model returns associated prosodic features. In various exemplary embodiments, the prosodic features are associated with discourse functions based on an associative array, relations between linked tables or various other methods of associating information.

The discourse function level prosodic features may include but are not limited to specific pitch frequency values, speed, intonation, and the like. In one of the various exemplary embodiments according to this invention, the discourse functions level prosodic feature waveform is a template of discourse function level prosodic features typically associated with discourse functions in human speech. However, the prosodic features may also be encoded into vectors, equations and or any other data structure and/or representation without departing from the scope of this invention. After the prosodic features associated with the discourse functions have been determined, control continues to step S260.

In step S260, adjustments to the discourse functions in the speech output are determined based on the discourse function level prosodic features. In one of the exemplary embodiments according to this invention, discourse function level prosodic waveforms are combined with the waveforms from a conventional text-to-speech conversion system. Since the prosodic features are mapped to discourse functions that in-turn reflect dialog acts, the reproduction of the prosodic features reduces the potential cognitive load on the speech recipient. In other exemplary embodiments according to this invention, discourse function level prosodic feature adjustments may also be performed on parameterized speech output. Moreover, it will be apparent that the speech may be adjusted before, during or after speech output generation without departing from the scope of this invention. After the adjusted synthesized speech has been determined, control continues to step S270.

In step S270, the adjusted synthesized speech is output. The adjusted synthesized speech may be output over a telephone system, an audio device or via any known or later developed communication medium. In various other exemplary embodiments according to this invention, the adjusted speech output may be prosodically annotated text, input to another program or any other type of adjusted synthesized speech information. After the adjusted synthesized speech has been output, control continues to step S280.

In step S280, a determination is made whether there are additional text portions to be synthesized. If it is determined that there are additional text portions to be synthesized, control continues to step S290 where the next portion of the input text is determined. After the next portion of the input text has been determined, control jumps immediately to step S230. Steps S230-S290 repeat until a no additional text portions remain to be synthesized. Control then continues to step S300 and the process ends.

FIG. 12 is an exemplary data structure for storing combined prosodic features according to one aspect of this invention. The exemplary data structure for storing combined prosodic features 1100 is comprised of a prosodic feature portion 1110 and a prosodic value portion 1120.

The prosodic feature portion 1110 identifies the type of prosodic feature. The prosodic feature portion 1110 optionally identifies the combined prosodic feature with an identifier. This allows any number of prosodic features such as volume, pitch frequency, preceding and following silence duration and/or any other features to be associated together into a combined prosodic feature. In various exemplary embodiments according to this invention, the prosodic features within a combined prosodic feature are represented as a multi-modal vector. However, it will be apparent that any know or later developed method of representing multiple prosodic features may be used in the practice of this invention.

The first row of the exemplary data structure for storing prosodic features 1100 contains the value “J[1].pitch_Frequency” in the prosodic feature portion 1110 and the value “75” in the prosodic value portion 1120. This indicates that a pitch frequency value of “75” is associated with combined prosodic feature “1”.

The second row of the exemplary data structure for storing prosodic features 1100 contains the value “J[1].silence_Following” in the prosodic feature portion 1110 and the value “Nil” in the prosodic value portion 1120. This indicates that the following silence prosodic feature is not used with combined prosodic feature “1”. The value of “0.25” in the third row of the data structure for storing prosodic features indicates that the combined prosodic feature “1” is associated with a 0.25 second silence preceding the speech.

The fourth row of the exemplary data structure for storing prosodic features 1100 contains the value “J[1].Volume” in the prosodic feature portion 1110 and the value “10” in the prosodic value portion 1120. This indicates that the combined prosodic feature is associated with an average volume of 10 decibels.

The fifth row of the exemplary data structure for storing prosodic features 1100 contains the value “J[1].Time” in the prosodic feature portion 1110 and the value “0.25” in the prosodic value portion 1120. This indicates that the prosodic feature occurs 0.25 seconds into the speech utterance. In this case, the speech utterance includes a preceding silence of 0.25 seconds.

Each of the circuits 10-70 of the system for synthesizing speech using discourse function level prosodic features 100 described in FIG. 3 can be implemented as portions of a suitably programmed general-purpose computer. Alternatively, 10-70 of the system for synthesizing speech using discourse function level prosodic features 100 outlined above can be implemented as physically distinct hardware circuits within an ASIC, or using a FPGA, a PDL, a PLA or a PAL, or using discrete logic elements or discrete circuit elements. The particular form each of the circuits 10-70 of the system for synthesizing speech using discourse function level prosodic features 100 outlined above will take is a design choice and will be obvious and predicable to those skilled in the art.

Moreover, the system for synthesizing speech using discourse function level prosodic features 100 and/or each of the various circuits discussed above can each be implemented as software routines, managers or objects executing on a programmed general purpose computer, a special purpose computer, a microprocessor or the like. In this case, the system for synthesizing speech using discourse function level prosodic features 100 and/or each of the various circuits discussed above can each be implemented as one or more routines embedded in the communications network, as a resource residing on a server, or the like. The system for synthesizing speech using discourse function level prosodic features 100 and the various circuits discussed above can also be implemented by physically incorporating the system for synthesizing speech using discourse function level prosodic features 100 into software and/or a hardware system, such as the hardware and software systems of a web server or a client device.

As shown in FIG. 3, memory 20 can be implemented using any appropriate combination of alterable, volatile or non-volatile memory or non-alterable, or fixed memory. The alterable memory, whether volatile or non-volatile, can be implemented using any one or more of static or dynamic RAM, a floppy disk and disk drive, a write-able or rewrite-able optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

The communication links 99 shown in FIGS. 1, and 3 can each be any known or later developed device or system for connecting a communication device to the system for synthesizing speech using discourse function level prosodic features 100, including a direct cable connection, a connection over a wide area network or a local area network, a connection over an intranet, a connection over the Internet, or a connection over any other distributed processing network or system. In general, the communication links 99 can be any known or later developed connection system or structure usable to connect devices and facilitate communication.

Further, it should be appreciated that the communication links 99 can be wired or wireless links to a network. The network can be a local area network, a wide area network, an intranet, the Internet, or any other distributed processing and storage network.

While this invention has been described in conjunction with the exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A method of synthesizing speech using discourse function level prosodic features comprising the steps of:
determining output information;
determining discourse functions in the output information;
determining a model of discourse function level prosodic features; and
determining adjusted synthesized speech output based on the discourse functions and the model of discourse function level prosodic features.

2. The method of claim 1, wherein the discourse functions are determined based on a theory of discourse analysis.

3. The method of claim 2, in which the theory of discourse analysis is at least one of: the Linguistic Discourse Model, the Unified Linguistic Discourse Model, Rhetorical Structures Theory, Discourse Structure Theory and Structured Discourse Representation Theory.

4. The method of claim 1, wherein the output information is at least one of text information and application output information.

5. The method of claim 1, wherein determining the adjusted synthesized speech output further comprises the steps of:
determining a synthesized speech output based on the output information;
determining discourse function level prosodic feature adjustments; and
determining adjusted synthesized speech output based on the synthesized speech output and the discourse level prosodic feature adjustments.

6. The system of claim 1, wherein the model of discourse function level prosodic features is a predictive model of discourse functions.

7. The method of claim 6, in which the predictive models are determined based on at least one of: machine learning and rules.

8. The method of claim 1, in which the prosodic features occur in at least one of a location: preceding, within and following the associated discourse function.

9. The method of claim 1, in which the prosodic features are encoded within a prosodic feature vector.

10. The method of claim 9, in which the prosodic feature vector is a multimodal feature vector.

11. The method of claim 1, in which the discourse function is an intra-sentential discourse function.

12. The method of claim 1, in which the discourse function is an inter-sentential discourse function.

13. A method of synthesizing speech using discourse function level prosodic features comprising the steps of:
determining output information;
determining discourse functions in the output information based on a contextually aware theory of discourse analysis;
determining a model of discourse function level prosodic features; and
determining adjusted synthesized speech output based on the discourse functions and the model of discourse function level prosodic features.

14. The method of claim 13, in which the context is at least one of: semantic, pragmatic, and syntactic context.

15. A system for synthesizing speech using discourse function level prosodic features comprising:
an input/output circuit for retrieving output information;
a processor that determines discourse functions in the output information; determines a model of discourse function level prosodic features; and which determines adjusted synthesized speech output based on the discourse functions and the model of discourse function level prosodic features.

16. The system of claim 15, wherein the discourse functions are determined based on a theory of discourse analysis.

17. The system of claim 16, in which the theory of discourse analysis is at least one of: the Linguistic Discourse Model, the Unified Linguistic Discourse Model, Rhetorical Structures Theory, Discourse Structure Theory and Structured Discourse Representation Theory.

18. The system of claim 15, wherein the output information is at least one of text information and application output information.

19. The system of claim 15, wherein the processor determines a synthesized speech output based on the output information; determines discourse function level prosodic feature adjustments; and determines adjusted synthesized speech output based on the synthesized speech output and the discourse level prosodic feature adjustments.

20. The system of claim 15, wherein the model of discourse function level prosodic features is a predictive model of discourse functions.

21. The system of claim 20, in which the predictive models are determined based on at least one of: machine learning and rules.

22. The system of claim 15, in which the prosodic features occur in at least one of a location: preceding, within and following the associated discourse function.

23. The system of claim 15, in which the prosodic features are encoded within a prosodic feature vector.

24. The system of claim 23, in which the prosodic feature vector is a multimodal feature vector.

25. The system of claim 15, in which the discourse function is an intra-sentential discourse function.

26. The system of claim 15, in which the discourse function is an inter-sentential discourse function.

27. A system for synthesizing speech using discourse function level prosodic features comprising:
an input/output circuit for retrieving output information;
a processor that determines discourse functions in the output information based on a context aware theory of discourse analysis; determines a model of discourse function level prosodic features; and which determines adjusted synthesized speech output based on the discourse functions and the model of discourse function level prosodic features.

28. The system of claim 27, in which the context is at least one of: semantic, pragmatic, and syntactic context.

29. A carrier wave encoded to transmit a control program, useable to program a computer to synthesize speech using discourse level prosodic features, to a device for executing the program, the control program comprising:
instructions for determining output information;
instructions for determining discourse functions in the output information;
instructions for determining a model of discourse function level prosodic features; and
instructions for determining adjusted synthesized speech output based on the discourse functions and the model of discourse function level prosodic features.

30. Computer readable storage medium comprising: computer readable program code embodied on the computer readable storage medium, the computer readable program code usable to program a computer to synthesize speech using discourse level prosodic features comprising the steps of:
determining output information;
determining discourse functions in the output information;
determining a model of discourse function level prosodic features; and
determining adjusted synthesized speech output based on the discourse functions and the model of discourse function level prosodic features.
